(19) United States
(12) Patent Application Publication
(10) Pub. No.: US 2017/0075634 A1
(43) Pub. Date: Mar. 16, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Kento HOSODA, Kanagawa (JP)

(73) Assignee: FUJI XEROX CO., LTD., Tokyo (JP)

(21) Appl. No.: 15/046,843

(22) Filed: Feb. 18, 2016

(30) Foreign Application Priority Data
Sep. 10, 2015 (JP) 2015-178214

(51) Int. Cl. G06F 3/12

(52) U.S. Cl. CPC G06F 3/1203; G06F 3/122; G06F 3/1224

(57) ABSTRACT

An information processing apparatus includes a memory, a registration-interval extracting unit, and a determining unit. The memory stores multiple documents having a predetermined relationship. Each of the documents is stored in association with a registration date. The registration-interval extracting unit extracts the interval between the registration dates of the documents. The determining unit determines that the documents are to be published if a predetermined day count and the interval between the registration dates of the documents satisfy a predetermined condition.

### CROSS-REFERENCE TO RELATED APPLICATIONS

This application is based on and claims priority under 35 USC 119 from Japanese Patent Application No. 2015-178214 filed Sep. 10, 2015.

### BACKGROUND

(i) Technical Field

The present invention relates to an information processing apparatus, an information processing method, and a non-transitory computer readable medium.

(ii) Related Art

Recently, for example, in regional medical cooperation, health professionals in various institutions, such as a clinic, a core hospital, and a rehabilitation center, have been trying to share all of the medical records about medical practices which were performed on the same patient in various medical institutions in the past.

### SUMMARY

According to an aspect of the invention, there is provided an information processing apparatus including a memory, a registration-interval extracting unit, and a determining unit. The memory stores multiple documents having a predetermined relationship. Each of the documents is stored in association with a registration date. The registration-interval extracting unit extracts the interval between the registration dates of the documents. The determining unit determines that the documents are to be published if a predetermined day count and the interval between the registration dates of the documents satisfy a predetermined condition.

### BRIEF DESCRIPTION OF THE DRAWINGS

Exemplary embodiments of the present invention will be described in detail based on the following figures, wherein:

FIG. 1 is a conceptual diagram illustrating an exemplary module configuration according to a first exemplary embodiment;

FIG. 2 is a diagram for describing an exemplary system configuration in which the exemplary embodiment is used;

FIG. 3 is a diagram for describing an exemplary process performed in regional medical cooperation;

FIG. 4 is a diagram for describing an exemplary process performed in regional medical cooperation;

FIG. 5 is a diagram for describing an exemplary process performed in regional medical cooperation;

FIG. 6 is a diagram for describing exemplary document registration;

FIG. 7 is a diagram for describing an exemplary data structure of a document attribute table;

FIG. 8 is a flowchart of an exemplary process according to the first exemplary embodiment;

FIG. 9 is a flowchart of an exemplary process according to the first exemplary embodiment;

FIG. 10 is a diagram for describing an exemplary process according to the first exemplary embodiment;

FIG. 11 is a conceptual diagram illustrating an exemplary module configuration according to a second exemplary embodiment;

FIG. 12 is a diagram for describing an exemplary process performed in regional medical cooperation;

FIG. 13 is a flowchart of an exemplary process according to the second exemplary embodiment;

FIG. 14 is a diagram for describing an exemplary data structure of a document attribute table;

FIG. 15 is a flowchart of an exemplary process according to the second exemplary embodiment;

FIG. 16 is a diagram for describing an exemplary process according to the second exemplary embodiment; and

FIG. 17 is a block diagram illustrating an exemplary hardware configuration of a computer for achieving the exemplary embodiments.

### DETAILED DESCRIPTION

Various types of exemplary desirable embodiments for implementing the present invention will be described below on the basis of the drawings.

### First Exemplary Embodiment

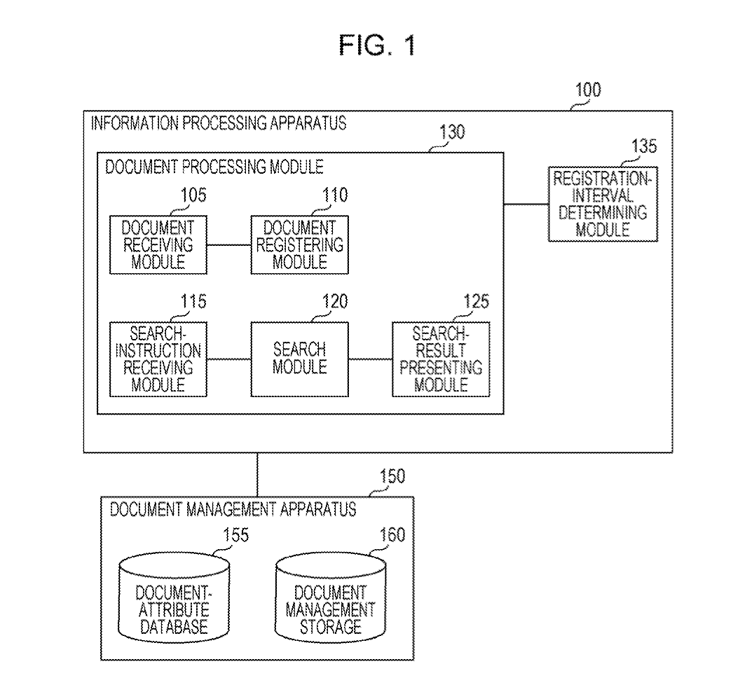

FIG. 1 is a conceptual diagram illustrating an exemplary module configuration according to a first exemplary embodiment.

In general, a module refers to a component, such as software (a computer program) that is logically separable or hardware. Thus, a module in the exemplary embodiment refers to not only a module in terms of a computer program but also a module in terms of a hardware configuration. Consequently, the description of the exemplary embodiment also serves as a description of a system, a method, and a computer program which cause the hardware configuration to function as a module (a program that causes a computer to execute procedures, a program that causes a computer to function as units, or a program that causes a computer to implement functions). For convenience of explanation, the terms “to store something” and “to cause something to store something”, and equivalent terms are used. These terms mean that a storage apparatus stores something or that a storage apparatus is controlled so as to store something, when the exemplary embodiment is achieved by using computer programs. One module may correspond to one function. However, in the implementation, one program may constitute one module, or one program may constitute multiple modules. In contrast, multiple programs may constitute one module. Additionally, multiple modules may be executed by one computer, or one module may be executed by multiple computers in a distributed or parallel processing environment. One module may include another module. Hereinafter, the term “connect” refers to logical connection, such as transmission/reception of data, an instruction, or reference relationship between pieces of data, as well as physical connection. The term “predetermined” refers to a state in which determination has been made before a target process. This term also includes a meaning in which determination has been made in accordance with the situation or state at that time or the situation or state before that time, not only before processes according to the exemplary embodiment start, but also before the target process starts even after the processes according to the exemplary embodiment have started. When multiple “predetermined values” are present, these may be different from each other, or two or more of the values (including all values, of course) may be the same. A description having a meaning of “when A is satisfied, B is performed” is used as having a meaning of “whether or not A is satisfied is determined and, when it is determined that A is satisfied, B is performed”. However, this term does not include a case where the determination of whether or not A is satisfied is unnecessary.

A system or apparatus refers to one in which multiple computers, pieces of hardware, devices, and the like are connected to each other by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) operating on man-made agreements.

A list of things means a list of examples, and encompasses either one of the examples and a combination of the examples. The expression “either one of examples” also encompasses only the one example, that is, the case in which examples other than the example are not included.

For each of the processes performed by the respective modules, or for each of the processes in the case where the processes are performed in a single module, target information is read out from a storage apparatus. After the process is performed, the processing result is written in a storage apparatus. Accordingly, description about the reading of data from the storage apparatus before the process and the writing into the storage apparatus after the process may not be made. Examples of the storage apparatus may include a hard disk, a random access memory (RAM), an external storage medium, a storage apparatus via a communication line, and a register in a central processing unit (CPU).

An information processing apparatus 100 according to the first exemplary embodiment publishes documents managed by a document management apparatus 150. As illustrated in the example in FIG. 1, the information processing apparatus 100 includes a document processing module 130 and a registration-interval determining module 135, and is connected to the document management apparatus 150.

In particular, information processing apparatuses in multiple institutions are connected to one another. Documents created in the information processing apparatus of a certain institution are allowed to be published to the information processing apparatuses of the other institutions. Hereinafter, medical documents (for example, patient charts, examination result memos, and surgical consent forms) are used as target documents.

To prevent many patients from going to a core hospital in a region, regional medical cooperation has been promoted so that cooperation of medical institutions in the region causes all of the institutions in the region to serve as a single medical system by taking advantage of features of each medical institution. Examples of a medical institution include a core hospital, a clinic, a rehabilitation center, and a visiting nurse station. In the description below, a case in which the information processing apparatus 100 is used in regional medical cooperation will be taken as an example. In this case, the information processing apparatus 100 excludes unnecessary documents from a large number of medical diagnosis/treatment documents, and obtains published documents in the regional medical cooperation.

A core hospital indicates a hospital which plays core roles in the regional medical cooperation. A core hospital indicates an institution in which more advanced medical care is provided when a specialized examination (for example, magnetic resonance imaging (MRI)) which is difficult to be performed by a family doctor, or a medical function (for example, a delivery or palliative care) which is difficult to be provided in other medical institutions needs to be performed.

In the first exemplary embodiment, a clinic, a rehabilitation center, and a visiting nurse station refer to institutions in which referral is used to receive/send a patient from/to a core hospital. In these institutions, medical records (documents) for a patient are also created.

The document management apparatus 150 includes a document-attribute database 155 and a document management storage 160, and is connected to the information processing apparatus 100. The document management apparatus 150 stores multiple documents which have a predetermined relationship and each of which is associated with a registration date. Examples of “having a predetermined relationship” include the same “patient”, the same “pharmaceutical drug”, and the same “medical equipment”. In each institution, when a patient is treated, a document for a “patient” who is the same as the patient may be used as a document “having a relationship”. When a clinical trial is carried out, a document for the same “pharmaceutical drug” or the same “medical equipment” which is the target of the clinical trial may be used as a document “having a relationship”. Description will be made by using a document for the same “patient” as a document “having a relationship”. Specifically, the document management apparatus 150 includes a document attribute table 700 stored in the document-attribute database 155, and the document management storage 160 storing documents themselves.

The document management storage 160 stores documents. For example, the documents may be stored as files in a file system in a computer.

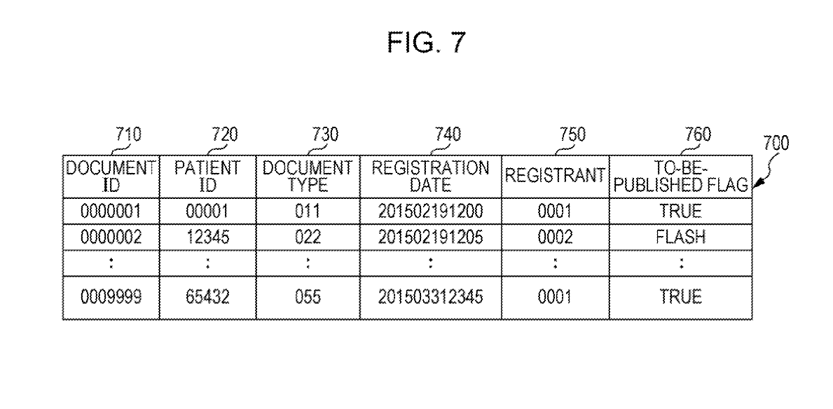

The document-attribute database 155 stores document attributes. For example, a document ID, a patient ID, a document type, a registration date, a registrant, and the like may be stored for each document. Further, a pharmaceutical drug ID, a medical equipment ID, and the like may be added for the clinical-trial use described above. For example, the document-attribute database 155 stores the document attribute table 700. FIG. 7 is a diagram for describing an exemplary data structure of the document attribute table 700. The document attribute table 700 has a document ID field 710, a patient ID field 720, a document type field 730, a registration date field 740, a registrant field 750, and a to-be-published flag field 760. The document ID field 710 stores information (document identification (ID)) for uniquely identifying a document in the first exemplary embodiment. The patient ID field 720 stores information (patient ID) for uniquely identifying a patient in the first exemplary embodiment. The document type field 730 stores the type of the document. Examples of a document type include the “examination report” and the “surgical consent form”. Specifically, information (template ID) indicating a template (a type, a format, or the like) used upon creation of the document may be used. The registration date field 740 stores a registration date (which may be represented by year, month, day, hour, minute, second, and subsecond resolution, or a combination of these) at which the document is registered in the document management apparatus 150. The registrant field 750 stores a person who has given an instruction to register the document. The to-be-published flag field 760 stores information about whether or not the document is to be published (the result of a process performed by the registration-interval determining module 135). “TRUE” indicates that the document is to be published, and “FALSE” indicates that the document is not to be published. Each row contains information about a corresponding one of documents. Therefore, each document has information in the to-be-published flag field 760.

The document processing module 130 includes a document receiving module 105, a document registering module 110, a search-instruction receiving module 115, a search module 120, and a search-result presenting module 125, and is connected to the registration-interval determining module 135. The document processing module 130 registers documents in the document management apparatus 150 and publishes (for example, subjects to viewing) documents in the document management apparatus 150 in accordance with an instruction from a user terminal which is present in a core hospital, a clinic, a rehabilitation center, a visiting nurse station, or the like.

The document receiving module 105 is connected to the document registering module 110. The document receiving module 105 receives a document to be registered, from a user terminal which is present in a core hospital, a clinic, a rehabilitation center, a visiting nurse station, or the like. A document is electronic data (also referred to as a file), such as, in most cases, text data, or occasionally a figure, an image, a movie, or a voice, or a combination of these. A document refers to an object which is a target to be, for example, stored, edited, and searched for, and which may serve as a separate unit in which exchange between systems or users is made, and encompasses a similar object. Specifically, examples of the document include a Web page and a document created by using a document preparation program. The document may be any as long as a registration-date attribute is added to the document, and, particularly, may be a document having a more widely compatible document format such as Portable Document Format (PDF). The formats of documents created in various institutions are not standardized. Therefore, the format of a document is desirably more widely compatible. The document receiving module 105 may receive a document having a more widely compatible document format, or may convert a document received from a user terminal apparatus, into a document having a more widely compatible document format.

The document registering module 110 is connected to the document receiving module 105. The document registering module 110 registers a document received by the document receiving module 105, in the document management apparatus 150. At that time, the document registering module 110 may add a document ID, a patient ID, a document type, a registration date, a registrant, and the like as attributes of the document. The detail of the attributes of a document is described above by using the example in FIG. 7. These attributes are stored in the document-attribute database 155, and the document itself is stored in the document management storage 160.

The search-instruction receiving module 115 is connected to the search module 120. The search-instruction receiving module 115 receives an instruction to search for documents stored in the document management apparatus 150, from a user terminal apparatus which is present in a core hospital, a clinic, a rehabilitation center, a visiting nurse station, or the like. For example, the search-instruction receiving module 115 receives a patient ID and/or the like, and receives an instruction to search for documents for the patient indicated by the patient ID.

The search module 120 is connected to the search-instruction receiving module 115 and the search-result presenting module 125. The search module 120 searches for documents in the document management apparatus 150 on the basis of the search instruction received by the search-instruction receiving module 115. Documents to be published are retrieved as a search result.

The search-result presenting module 125 is connected to the search module 120. To present the search result on the user terminal apparatus of the operator who has given the search instruction, the search-result presenting module 125 transmits the search result obtained by the search module 120. The documents to be presented are those to be published. Documents not to be published may be presented on the basis of an instruction, a setting, or the like made by a user. For example, information describing that documents that are associated with the patient ID for which search is to be performed and that are not to be published are present (for example, information about the number of such documents in each registered institution) may be presented, and the documents not to be published may be viewed on the basis of a user instruction.

The registration-interval determining module 135 is connected to the document processing module 130. The registration-interval determining module 135 extracts intervals between the registration dates of the multiple documents. Specifically, documents are chronologically arranged on the basis of the registration dates of the documents, and the difference between the registration dates of two adjacent documents is calculated. The two documents between which the interval is extracted are “documents having a predetermined relationship” described above. For example, examples of such documents include documents for the same patient as a search target, documents for the same pharmaceutical drug as a search target, and documents for the same medical equipment as a search target. Further, the interval between the registration dates of documents having the same document type may be used. The “two documents” are a document B which is a search target and a document A which has been registered before the document B.

When the predetermined number of days and the interval between the registration dates of the multiple documents satisfy a predetermined condition, the registration-interval determining module 135 determines that the multiple documents are to be published. “The predetermined number of days” may be, for example, the number of days which is a statistical value of past registration intervals, such as one day, as described below.

The registration-interval determining module 135 may determine that documents are not to be published when the predetermined number of days and the interval between the registration dates of the documents do not satisfy the predetermined condition.

The “predetermined condition” may be the following condition: the interval between the registration dates of documents falls within a predetermined range determined with respect to a statistical value of the past registration intervals, or the interval between the registration dates of the documents is equal to or less than one day. The statistical value is a result obtained by performing a statistical process on the past registration intervals. Specifically, the statistical value is the average, the most frequent value, the median value, the minimum value, the maximum value, or the like of the past registration intervals. The term “past” encompasses a limited period. For example, the term “past” may encompass a predetermined period extending back from the current time, or may encompass a predetermined number of events which have occurred in the past. The predetermined number encompasses once, and one past event means the previous event. Description will be made below by using, as an example of the “statistical value”, the registration interval of the previous event. Examples of “within a predetermined range” include (1) a condition in which the interval between the registration dates of documents is equal to or shorter than the statistical value of the past registration intervals, and (2) a condition in which the interval between the registration dates of documents does not fall within X% above or below the statistical value of the past registration intervals. The condition (1) is a condition produced from a tendency in which the registration interval between important documents is short. The condition (2) is determined so as to publish documents created at uneven intervals, and is produced from a tendency in which documents which are repeatedly registered at regular intervals, such as documents created in observation, contain similar information, as described below. Such documents do not need to be published.

The registration-interval determining module 135 may determine that a document which is registered first as having the document type of multiple documents having a predetermined relationship is to be published.

A timing at which the registration-interval determining module 135 performs processing may be either of a timing at which the document registering module 110 registers a document, a timing at which the search module 120 retrieves a document, and a timing at which the search-result presenting module 125 transmits a search result. Description will be made below by taking a timing at which the document registering module 110 registers a document, as an example.

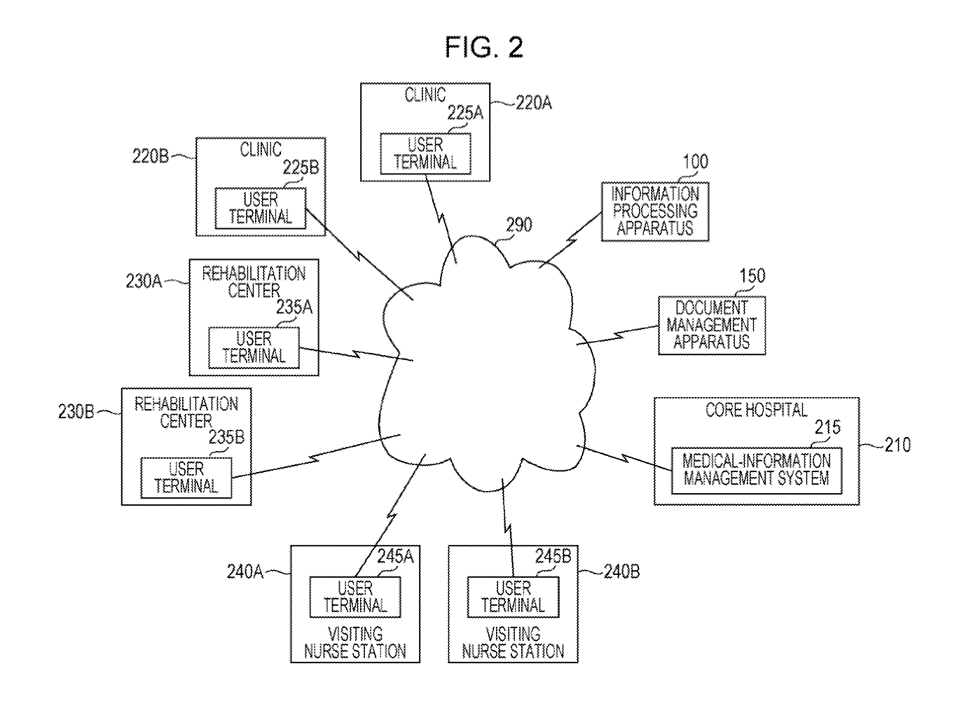

FIG. 2 is a diagram for describing an exemplary system configuration in which the first exemplary embodiment is used.

The information processing apparatus 100, the document management apparatus 150, a medical-information management system 215, a user terminal 225A, a user terminal 225B, a user terminal 235A, a user terminal 235B, a user terminal 245A, and a user terminal 245B are connected to one another via a communication line 290. A core hospital 210 is provided with the medical-information management system 215. A clinic 220 is provided with a user terminal 225. A rehabilitation center 230 is provided with a user terminal 235. A visiting nurse station 240 is provided with a user terminal 245. The communication line 290 may be a wireless line, a wired line, or a combination of these. For example, the communication line 290 may be the Internet, an intranet, or the like serving as a communication infrastructure. The functions performed by the information processing apparatus 100, the document management apparatus 150, and the medical-information management system 215 may be implemented as a cloud service.

The medical-information management system 215 creates and manages documents about treatment provided in the core hospital 210. In addition, the medical-information management system 215 performs a process for regional medical cooperation. The information processing apparatus 100 and the document management apparatus 150 may be disposed in the core hospital 210, or may be included in the medical-information management system 215.

Documents created in the institutions (the core hospital 210, the clinics 220, the rehabilitation centers 230, and the visiting nurse stations 240) are stored in the document management apparatus 150 via the information processing apparatus 100. Documents in the document management apparatus 150 are published on the basis of search instructions from the institutions. For example, when a patient comes to a clinic 220 or the like, a search instruction including the patient ID is given in order to search for the past medical treatment history, on the basis of an operation performed by a person in charge (for example, a doctor). Documents which are set as being published, through the process performed by the information processing apparatus 100 are presented as the search result.

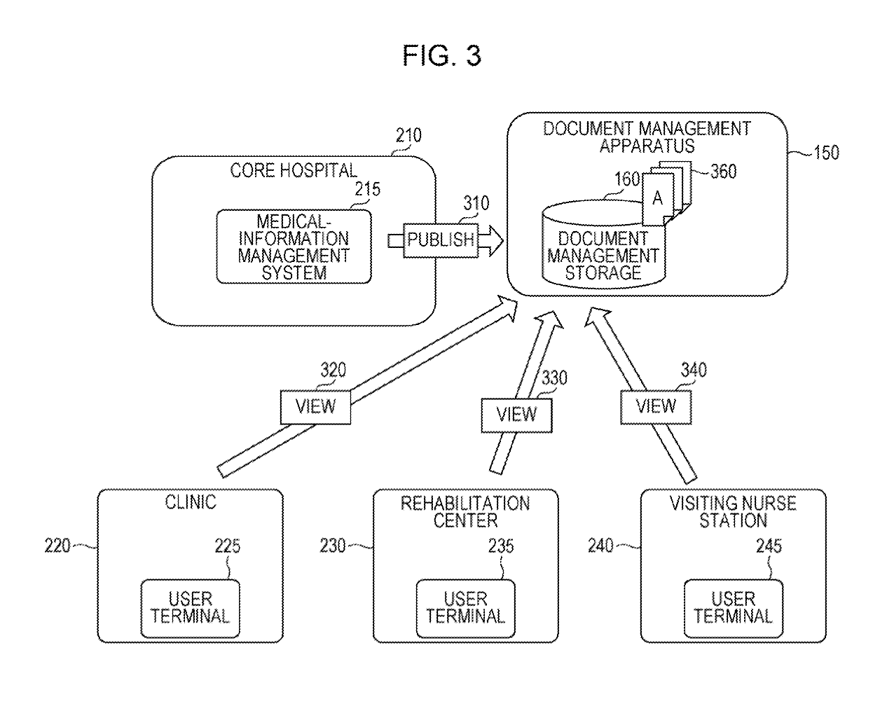

FIG. 3 is a diagram for describing an exemplary process performed in regional medical cooperation.

The document management storage 160 of the document management apparatus 150 stores medical record documents 360 for a patient A. For example, to improve the medical quality in the entire region, the core hospital 210 in the region publishes (310) (stores in the document management storage 160) the documents managed by the core hospital 210 so as to make external institutions (the clinics 220, the rehabilitation centers 230, and the visiting nurse stations 240) view (320, 330, and 340) the documents.

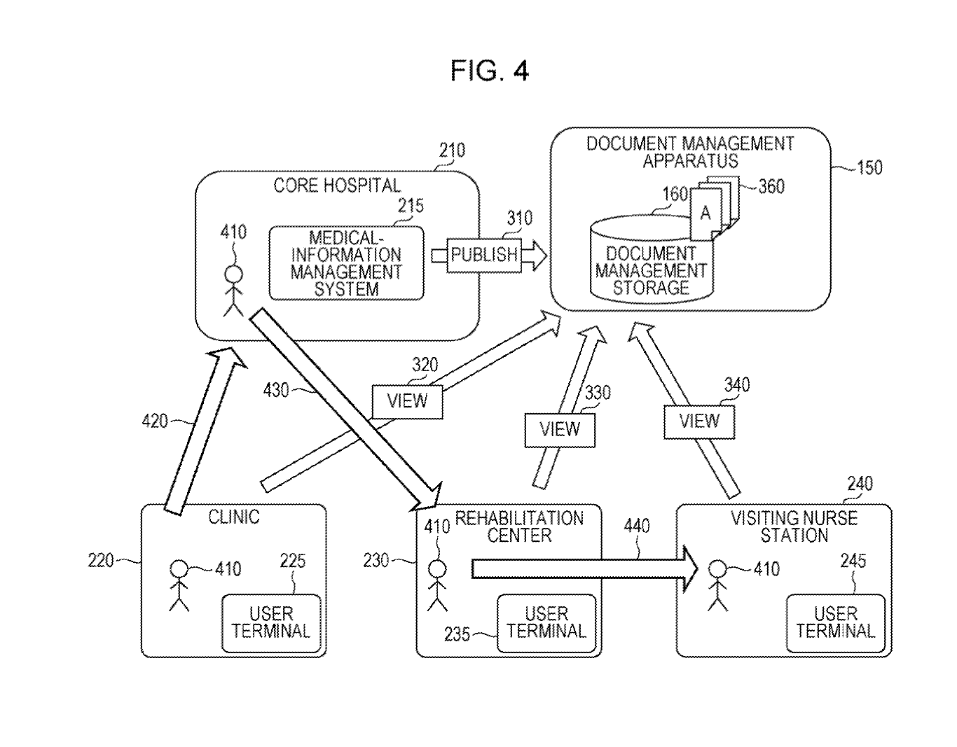

FIG. 4 is a diagram for describing an exemplary process performed in regional medical cooperation.

For example, a patient A 410 moves from an institution to another (in FIG. 4, a move 420 of the patient A from a clinic 220 to the core hospital 210, a move 430 of the patient A from the core hospital 210 to a rehabilitation center 230, and a move 440 of the patient A from the rehabilitation center 230 to a visiting nurse station 240), and gets medical treatment.

In this case, to provide information obtained while the patient gets medical treatment in an institution, to the next institution, processes, such as the publishing 310 and the viewing 320, are performed.

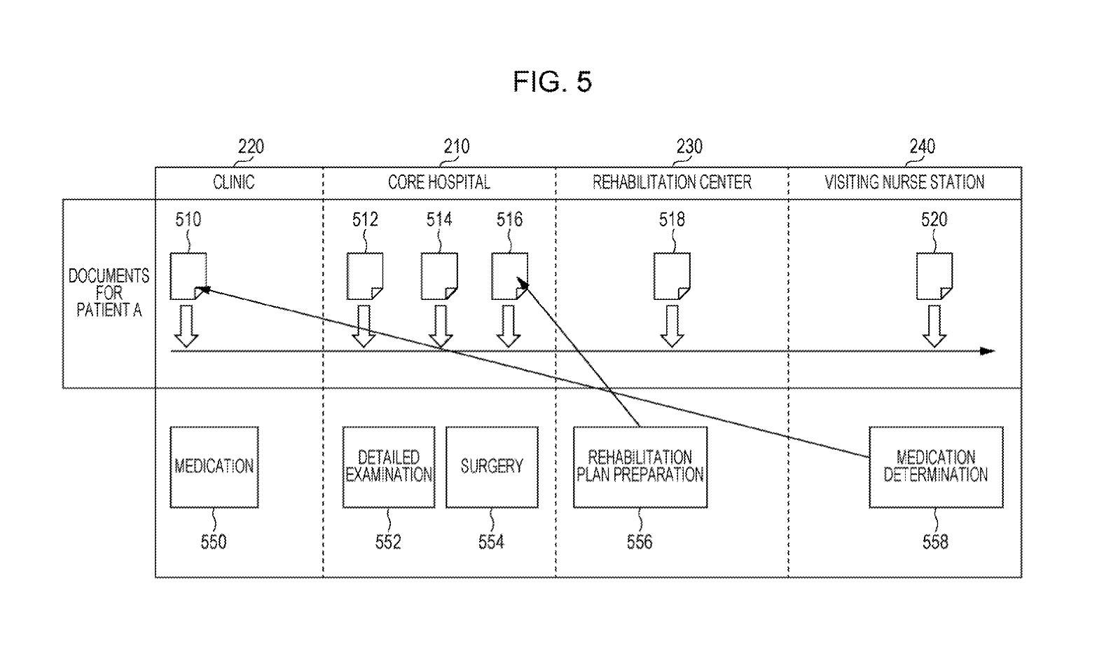

FIG. 5 is a diagram for describing an exemplary process performed in regional medical cooperation.

In the clinic 220, medication 550 is given, and medication information 510 and the like are created as documents for the patient A 410, and are registered in the document management storage 160.

In the core hospital 210, a detailed examination 552 and surgery 554 are undergone, and a detailed-examination record 512, a surgery record 514, a hospital-discharge record 516, and the like are created as documents for the patient A 410, and are registered in the document management storage 160.

In the rehabilitation center 230, rehabilitation plan preparation 556 is performed, and a rehabilitation plan sheet 518 and the like are created as documents for the patient A 410, and are registered in the document management storage 160.

In the visiting nurse station 240, medication determination 558 is made, and medication information 520 and the like are created as documents for the patient A 410, and are registered in the document management storage 160.

In the rehabilitation plan preparation 556 in the rehabilitation center 230, the hospital-discharge record 516 created in the core hospital 210 is referred to.

In the medication determination 558 in the visiting nurse station 240, the medication information 510 created in the clinic 220 is referred to.

Thus, medical practices which have been done in the past in different institutions are allowed to be checked, allowing a correct and efficient medical practice to be given. However, four documents for the patient A 410 are registered at the time point of the rehabilitation plan preparation 556; five documents are registered at the time point of the medication determination 558; but only one document is necessary at each time point. That is, pieces of medical information of the target patient which are registered from all of the institutions are allowed to be checked, and, in most cases, a large amount of information has to be checked. Important information missed due to a large amount of information that is to be checked may cause a malpractice.

Therefore, it is necessary to address the situation in which a large amount of information unnecessary for the target treatment is present when documents registered in other institutions are viewed.

On the other hand, in regional medical cooperation, computerization in all of the institutions is not always made. Even when institutions are computerized, the electronic health record vendor for one institution is different from that for another institution in many cases. That is, compatibility has not been achieved.

Therefore, transmission of information between institutions is often performed by using unstructured data (such as PDF). A simple attribute search which is performed so as to avoid publication of unnecessary information, and in which the number of pieces of retrieved information is narrowed down by using an attribute is not useful for practical use.

Typically, treatment is not always undergone. In most of a period, observation is performed. In the observation period, examination is periodically performed. If an abnormality is not found in an examination result for the disease, the observation is continuously performed. Some patients have many documents created in the observation period in addition to treatment records.

This is a reason why really important documents (documents about treatment) are difficult to find.

Medical treatment has the following characteristic: when the condition of a patient is steady, observation is continuously performed; and, when the condition of a patient takes a turn, documents tend to be intensively registered in a short period. In addition, information about observation has a characteristic in which information obtained in an observation is similar to that in the previous observation. For example, many patients for whom many documents are present have handicaps or the like since birth and have got treatment for several decades.

However, there is a characteristic in which such persons get observation in most of the period.

Therefore, exclusion of information about observation achieves exclusion of information unnecessary for the treatment.

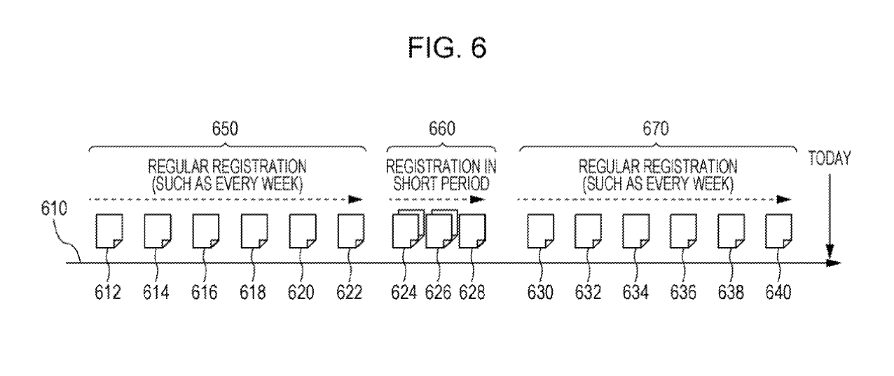

For example, documents are registered as illustrated in FIG. 6. In a period 650 on a time axis 610, documents (documents 612 to 622) are regularly registered (for example, every week). Information described in the documents obtained through observation are almost the same. In a period 660 in which some treatment is undergone, documents (documents 624 to 628) are registered in a short period. In a period 670, documents (documents 630 to 640) are regularly registered (for example, every week) again. However, in the early stage after treatment (a period in which the document 630 and the document 632 are created), pieces of information described in the documents may be likely to be different from each other.

Therefore, in the example in FIG. 6, documents to be published (documents to be viewed from other institutions) are the document 612, the document 614, the document 624, the document 626, the document 628, the document 630, and the document 632.

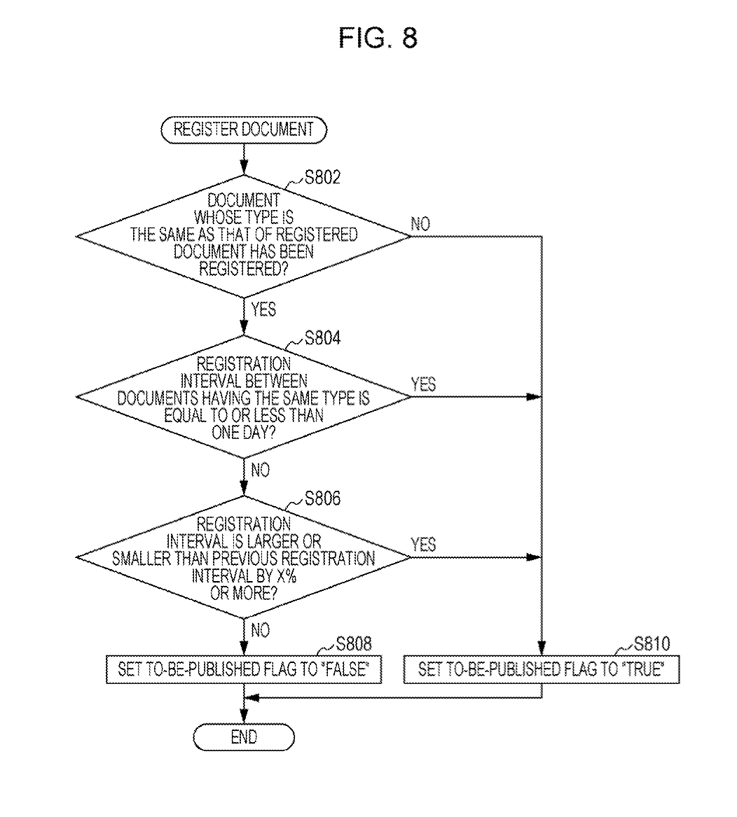

FIG. 8 is a flowchart of an exemplary process performed according to the first exemplary embodiment (by the registration-interval determining module 135). The exemplary process is a process performed when a document is to be registered. Target documents are documents for a patient for whom the document is to be registered.

In step S802, the registration-interval determining module 135 determines whether or not a document whose document type is the same as that of the document to be registered has been registered. If such a document has not been registered, the process proceeds to step S810. Otherwise, the process proceeds to step S804. Specifically, by using the values in the document type field 730 in the document attribute table 700, the registration-interval determining module 135 determines whether or not the document types are the same. For example, if the document type of the document to be registered is not present among those of the documents registered for the patient (if the document is the first document having the document type), the determination result is NO.

In step S804, the registration-interval determining module 135 determines whether or not the registration interval between the documents having the same document type is equal to or less than one day. If the registration interval is equal to or less than one day, the process proceeds to step S810. Otherwise, the process proceeds to step S806.

In step S806, the registration-interval determining module 135 determines whether or not the registration interval is larger or smaller than the previous registration interval by X% or more. If the registration interval is larger or smaller than the previous registration interval by X% or more, the process proceeds to step S810, Otherwise, the process proceeds to step S808. For example, 20% is used as X%.

In step S808, the to-be-published flag is set to “FALSE”. That is, the document is not to be published.

In step S810, the to-be-published flag is set to “TRUE”. That is, the document is to be published. The to-be-published flag determined in step S808 or S810 is stored in the to-be-published flag field 760 in the document attribute table 700.

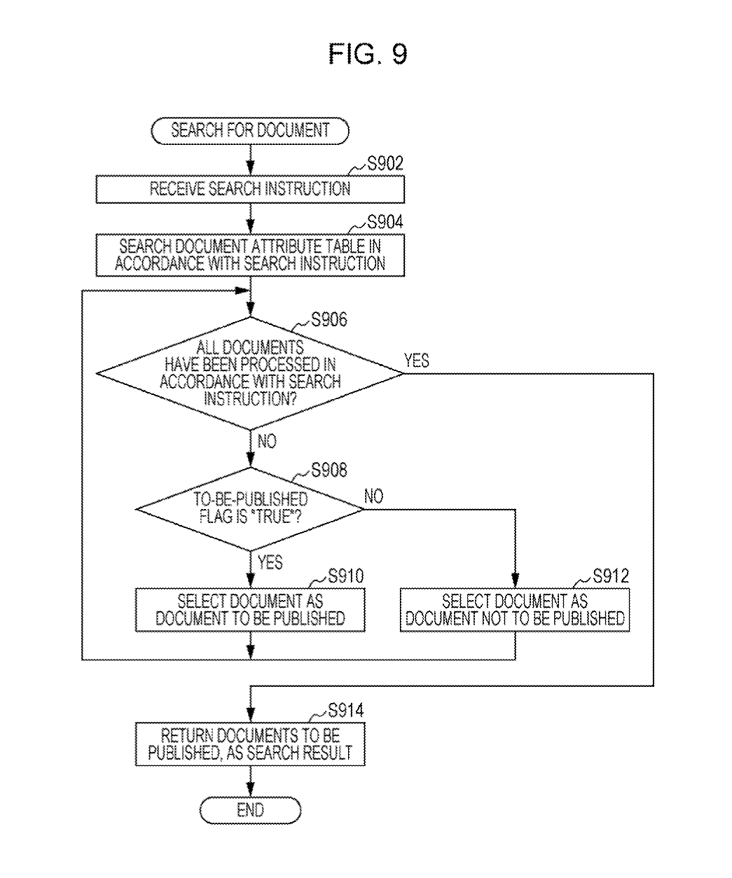

FIG. 9 is a flowchart of an exemplary process according to the first exemplary embodiment. This process is an exemplary search process performed after the process illustrated in the example in FIG. 8 is performed.

In step S902, the search-instruction receiving module 115 receives a search instruction. For example, a patient ID and/or the like are specified.

In step S904, the search module 120 searches the document attribute table 700 in accordance with the search instruction.

In step S906, the search module 120 determines whether or not all of the documents have been processed. If all of the documents have been processed in accordance with the search instruction, the process proceeds to step S914. Otherwise, the process proceeds to step S908.

In step S908, the search module 120 determines whether or not the to-be-published flag is “TRUE”. If the to-be-published flag is “TRUE”, the process proceeds to step S910. Otherwise, the process proceeds to step S912.

In step S910, the search module 120 selects the document as a document to be published, and the process returns back to step S906.

In step S912, the search module 120 selects the document as a document not to be published, and the process returns back to step S906.

In step S914, the search-result presenting module 125 returns documents to be published, as a search result.

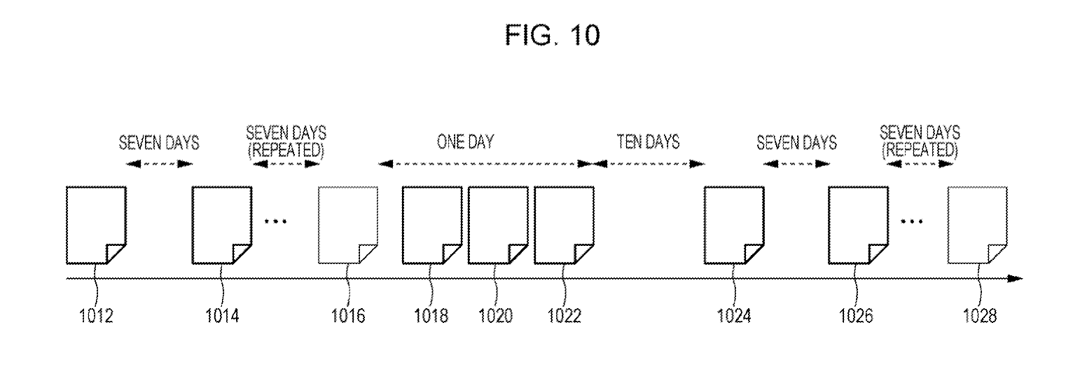

FIG. 10 is a diagram for describing an exemplary process according to the first exemplary embodiment. The example in FIG. 10 is an example in which documents are chronologically arranged on the basis of the registration date from left (past) to right (present), and in which the registration intervals are illustrated. A document illustrated with a thick frame is a document to be published.

How the documents relate to the flowchart illustrated in the example in FIG. 8 will be described below,

For a document 1012 which is registered first, the determination result in step S802 is NO.

For a document 1014, the determination result in step S806 is YES because the previous registration interval is “none”, and the target registration interval is “seven days”.

For each of documents 1014 to 1016, the registration interval is “seven days”. For the documents from the next document of the document 1014 to the document 1016, the determination result in step S806 is NO because the previous registration interval is “seven days”, and the target registration interval is “seven days”, That is, observation is repeatedly performed during this period, and the documents are not to be published.

For documents 1018, 1020, and 1022, the determination result in step S804 is YES because all of the documents are registered within one day.

For a document 1024, the determination result in step S806 is YES because the previous registration interval is “one day”, and the target registration interval is “ten days”.

For a document 1026, the determination result in step S806 is YES because the previous registration interval is “ten days”, and the target registration interval is “seven days”.

For each of documents 1026 to 1028, the registration interval is “seven days”. For documents from the next document of the document 1026 to the document 1028, the determination result in step S806 is NO because the previous registration interval is “seven days”, and the target registration interval is “seven days”.

### Second Exemplary Embodiment

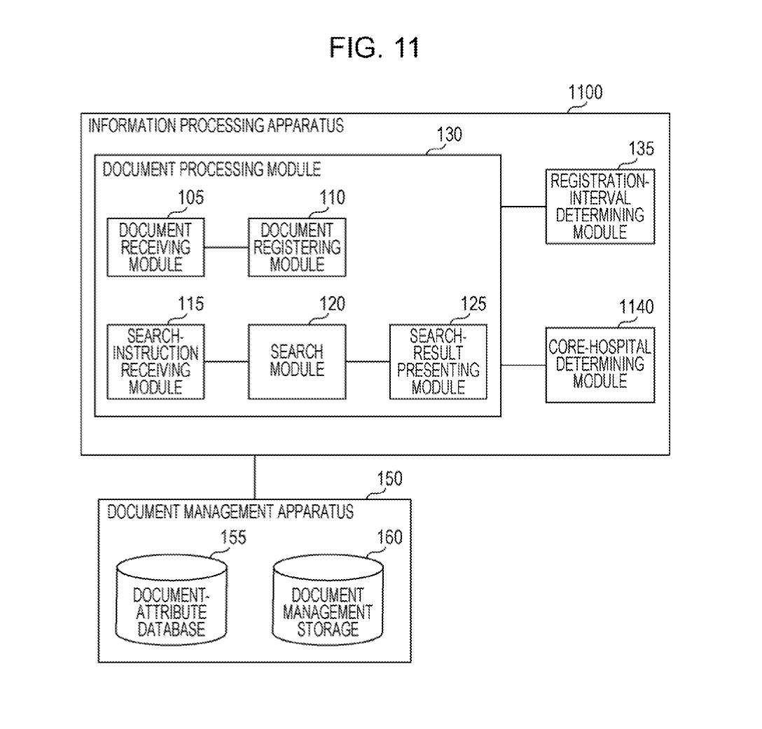

FIG. 11 is a conceptual diagram illustrating an exemplary module configuration according to a second exemplary embodiment. In the second exemplary embodiment, documents recorded in a core hospital are not excluded. The reason is as follows: since even regular treatment in the core hospital is treatment for advanced medical care, exclusion of the documents recorded in the core hospital increases the possibility of malpractice.

An information processing apparatus 1100 includes the document processing module 130, the registration-interval determining module 135, and a core-hospital determining module 1140, and is connected to the document management apparatus 150. Components of the same type as that in the first exemplary embodiment are designated with identical reference numerals, and repeated description will be avoided. That is, the information processing apparatus 1100 is obtained by adding the core-hospital determining module 1140 to the information processing apparatus 100.

The document processing module 130 includes the document receiving module 105, the document registering module 110, the search-instruction receiving module 115, the search module 120, and the search-result presenting module 125, and is connected to the registration-interval determining module 135 and the core-hospital determining module 1140.

The document receiving module 105 is connected to the document registering module 110.

The document registering module 110 is connected to the document receiving module 105.

The search-instruction receiving module 115 is connected to the search module 120.

The search module 120 is connected to the search-instruction receiving module 115 and the search-result presenting module 125.

The search-result presenting module 125 is connected to the search module 120.

The registration-interval determining module 135 is connected to the document processing module 130.

The core-hospital determining module 1140 is connected to the document processing module 130. The core-hospital determining module 1140 determines that a document registered in a predetermined institution be to be published. An example of the “predetermined institution” is a core hospital.

The document management apparatus 150 includes the document-attribute database 155 and the document management storage 160, and is connected to the information processing apparatus 1100.

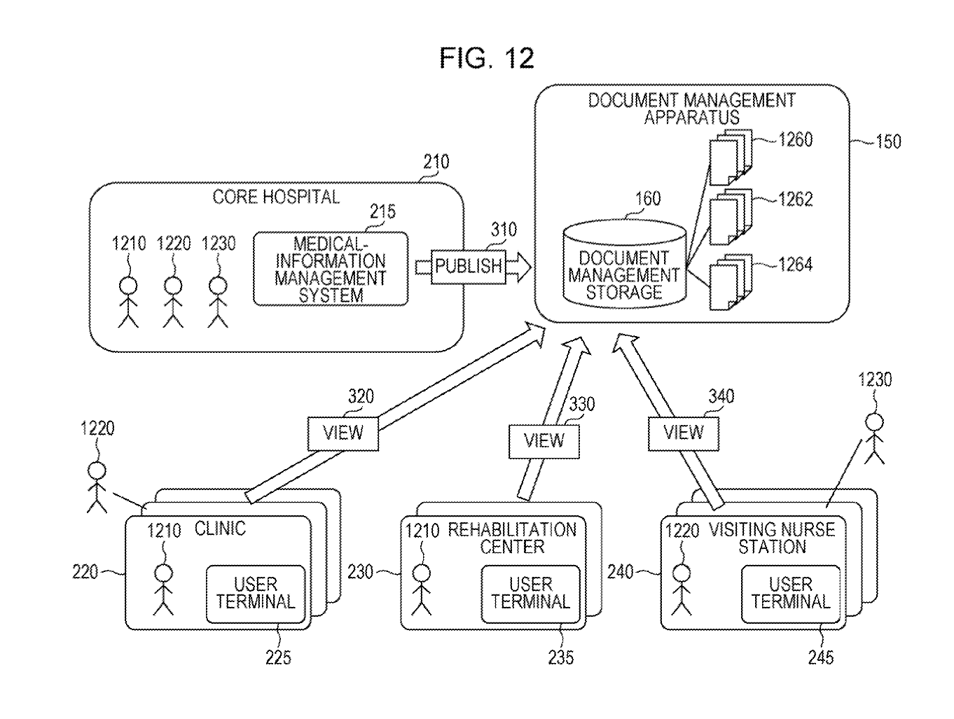

FIG. 12 is a diagram for describing an exemplary process performed in regional medical cooperation.

The document management storage 160 stores medical record documents 1260 for a patient A, medical record documents 1262 for a patient B, and medical record documents 1264 for a patient C. A patient A 1210 moves among institutions, a clinic 220, the core hospital 210, and a rehabilitation center 230. A patient B 1220 moves among institutions, a clinic 220, the core hospital 210, and a visiting nurse station 240. A patient C 1230 moves between institutions, the core hospital 210 and a visiting nurse station 240. That is, attention is focused on the fact that every patient participating in regional medical cooperation moves among institutions via the core hospital 210. Therefore, the following expressions hold.

The number of patients of the core hospital=the number of patients in regional medical cooperation

The number of patients of each institution (such as a clinic 220)<the number of patients in regional medical cooperation

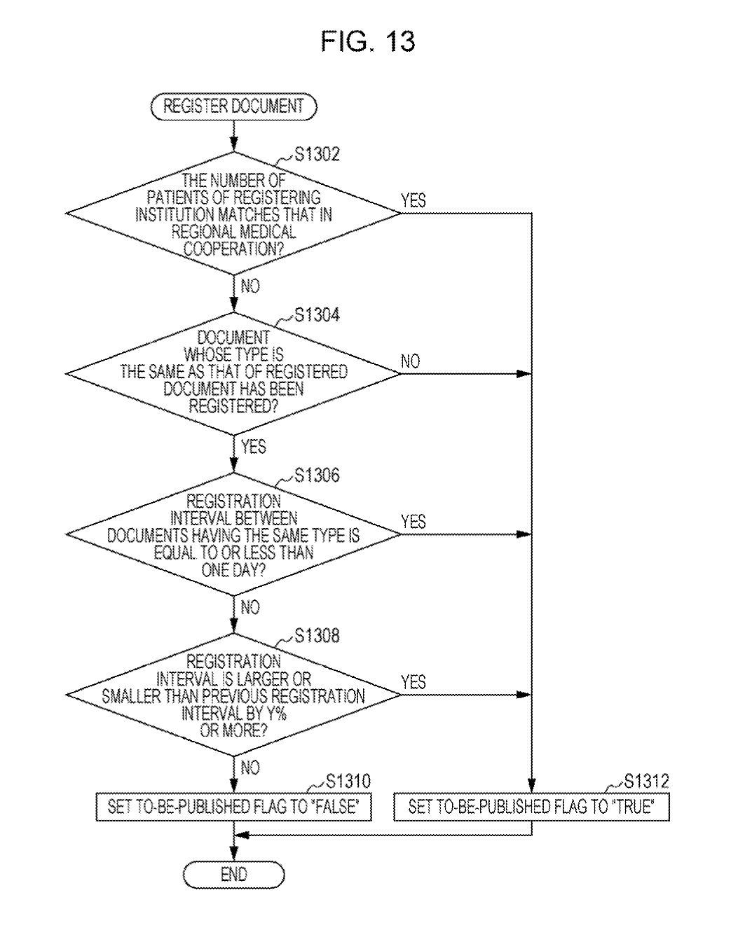

FIG. 13 is a flowchart of an exemplary process performed according to the second exemplary embodiment (by the registration-interval determining module 135). The exemplary process is performed when a document is to be registered. The flowchart is obtained by adding the process in step S1302 to the flowchart illustrated in the example in FIG. 8.

In step S1302, the core-hospital determining module 1140 determines whether or not the number of patients of the institution that has registered the document matches the number of patients in regional medical cooperation. If the number of patients of the institution that has registered the document matches the number of patients in regional medical cooperation, the process proceeds to step S1312. Otherwise, the process proceeds to step S1304. All of the patients move among institutions via the core hospital. In contrast, only some of the patients use a clinic or the like. Therefore, when the number of patients of the institution matches the number of patients in regional medical cooperation, it may be determined that the institution is the core hospital.

In step S1304, the registration-interval determining module 135 determines whether or not a document whose document type is the same as that of the document to be registered has been registered. If such a document has not been registered, the process proceeds to step S1312. Otherwise, the process proceeds to step S1306.

In step S1306, the registration-interval determining module 135 determines whether or not the registration interval between the documents having the same document type is equal to or less than one day. If the registration interval is equal to or less than one day, the process proceeds to step S1312. Otherwise, the process proceeds to step S1308.

In step S1308, the registration-interval determining module 135 determines whether or not the registration interval is larger or smaller than the previous registration interval by Y% or more. If the registration interval is larger or smaller than the previous registration interval by Y% or more, the process proceeds to step S1312. Otherwise, the process proceeds to step S1310. For example, 20% is used as Y%.

In step S1310, the registration-interval determining module 135 sets the to-be-published flag to “FALSE”.

In step S1312, the registration-interval determining module 135 sets the to-be-published flag to “TRUE”.

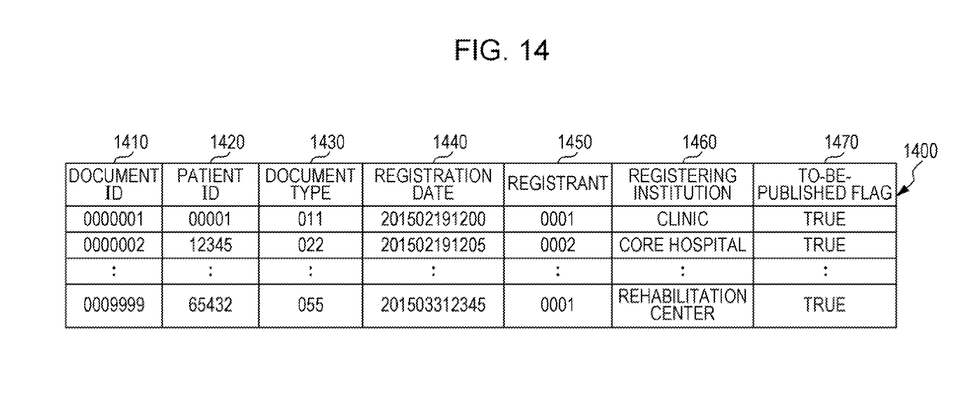

The information processing apparatus 1100 may recognize an institution which has registered the document, and may store this information as an attribute of the document in the document-attribute database 155. For example, the document management apparatus 150 stores a document attribute table 1400. FIG. 14 is a diagram for describing an exemplary data structure of the document attribute table 1400. The document attribute table 1400 is obtained by adding a registering-institution field 1460 to the document attribute table 700 illustrated in the example in FIG. 7. The document attribute table 1400 has a document ID field 1410, a patient ID field 1420, a document type field 1430, a registration date field 1440, a registrant field 1450, the registering-institution field 1460, and a to-be-published flag field 1470. The document ID field 1410 stores a document ID. The patient ID field 1420 stores a patient ID. The document type field 1430 stores a document type. The registration date field 1440 stores a registration date. The registrant field 1450 stores a registrant. The registering-institution field 1460 stores an institution which has registered the document. As described above, this is the result of recognition of an institution which has registered the document. For example, information indicating the core hospital, a clinic, or the like is stored. This information may indicate whether or not the institution is the core hospital. The to-be-published flag field 1470 stores information describing whether or not the document is to be published.

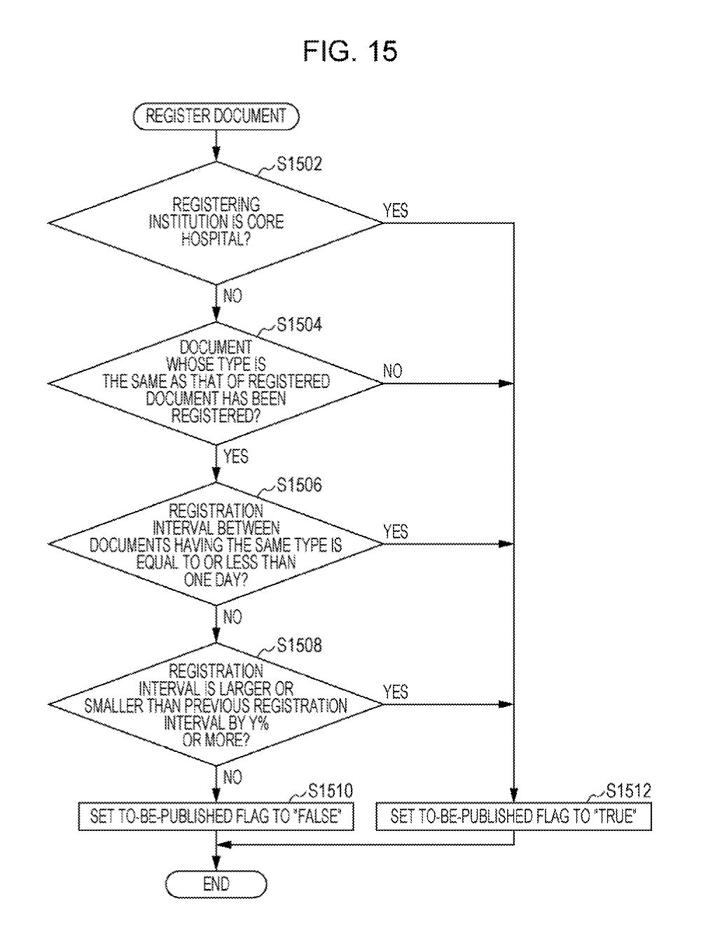

FIG. 15 is a flowchart of an exemplary process performed according to the second exemplary embodiment (by the registration-interval determining module 135). The exemplary process is performed when a document is to be registered in a state in which the document management apparatus 150 stores the document attribute table 1400.

In step S1502, the core-hospital determining module 1140 determines whether or not the institution which has registered the document is the core hospital. If the institution is the core hospital, the process proceeds to step S1512. Otherwise, the process proceeds to step S1504. Specifically, the determination is made by using the registering-institution field 1460 of the document attribute table 1400.

In step S1504, the registration-interval determining module 135 determines whether or not a document whose document type is the same as that of the document to be registered has been registered. If such a document has not been registered, the process proceeds to step S1512. Otherwise, the process proceeds to step S1506.

In step S1506, the registration-interval determining module 135 determines whether or not the registration interval between the documents having the same document type is equal to or less than one day. If the registration interval is equal to or less than one day, the process proceeds to step S1512. Otherwise, the process proceeds to step S1508.

In S1508, the registration-interval determining module 135 determines whether or not the registration interval is larger or smaller than the previous registration interval by Y% or more. If the registration interval is larger or smaller than the previous registration interval by Y% or more, the process proceeds to step S1512. Otherwise, the process proceeds to step S1510. For example, 20% is used as Y%.

In step S1510, the registration-interval determining module 135 sets the to-be-published flag to “FALSE”.

In step S1512, the registration-interval determining module 135 sets the to-be-published flag to “TRUE”.

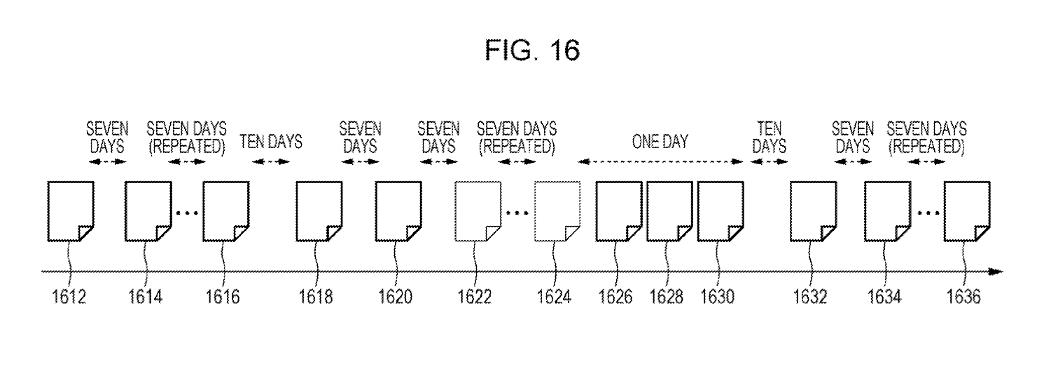

FIG. 16 is a diagram for describing an exemplary process according to the second exemplary embodiment. The example in FIG. 16 is an example in which documents are chronologically arranged on the basis of the registration date from left (past) to right (present), and in which the registration intervals are illustrated. A document illustrated with a thick frame is a document to be published.

How the documents relate to the flowcharts illustrated in the examples in FIGS. 13 and 15 will be described below.

Assume that documents 1612 to 1616 and documents 1632 to 1636 are registered in the core hospital, and that the other documents are registered in institutions other than the core hospital.

For the documents 1612 to 1616 and the documents 1632 to 1636 which are registered in the core hospital, the determination result in step S1302 or S1502 is YES. That is, the next document of the document 1614 to the document 1616, and documents from the next document of the document 1634 to the document 1636 are to be published because the documents are registered in the core hospital although the previous registration interval of “seven days” is equal to the target registration interval of “seven days”.

For a document 1618, the determination result in step S1308 or S1508 is YES because the previous registration interval is “seven days” and the target registration interval is “ten days”.

For a document 1620, the determination result in step S1308 or S1508 is YES because the previous registration interval is “ten days” and the target registration interval is “seven days”.

For documents 1622 to 1624, the determination result in step S1308 or S1508 is NO. That is, in this period, observation is repeatedly performed in an institution other than the core hospital. Therefore, the documents are not to be published.

For documents 1626, 1628, and 1630, the determination result in step S1306 or S1506 is YES because all of the documents are registered within one day.

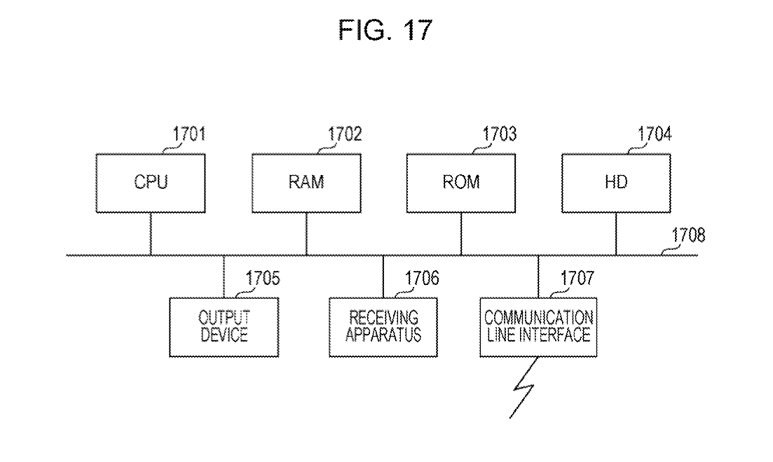

As illustrated in FIG. 17, the hardware configuration of a computer in which programs achieving the exemplary embodiments are executed constitutes a typical computer, and specifically constitutes a computer or the like which may serve as a personal computer or a server. That is, for example, the configuration employs a CPU 1701 as a processor (arithmetic logical unit), and employs a RAM 1702, a read-only memory (ROM) 1703, and an HD 1704 as storage devices. For example, a hard disk or a solid state drive (SSD) may be used as the HD 1704. The computer includes the following components: the CPU 1701 which executes programs for the document receiving module 105, the document registering module 110, the search-instruction receiving module 115, the search module 120, the search-result presenting module 125, the document processing module 130, the registration-interval determining module 135, the core-hospital determining module 1140, and the like; the RAM 1702 which is used to store the programs and data; the ROM 1703 which is used to store programs and the like for starting the computer; the HD 1704 which is an auxiliary memory (which may be a flash memory or the like) which serves as the document-attribute database 155 and the document management storage 160; a receiving apparatus 1706 which accepts data on the basis of an operation performed by a user on a keyboard, a mouse, a touch panel, or the like; an output device 1705, such as a cathode-ray tube (CRT), a liquid crystal display, or a speaker; a communication line interface 1707 for establishing a connection to a communication network, such as a network interface card; and a bus 1708 for connecting the above-described components to each other and for receiving/transmitting data. Computers having this configuration may be connected to one another via a network.

For an exemplary embodiment achieved by using computer programs among the above-described exemplary embodiments, the computer programs which are software are read into a system having the hardware configuration, and the software and hardware resources cooperate with each other to achieve the above-described exemplary embodiments.

The hardware configuration illustrated in FIG. 17 is merely one exemplary configuration. The exemplary embodiments are not limited to the configuration in FIG. 17, and may have any configuration as long as the modules described in the exemplary embodiments may be executed. For example, some modules may be constituted by dedicated hardware, such as an application specific integrated circuit (ASIC), and some modules which are installed in an external system may be connected through a communication line. In addition, systems having the configuration illustrated in FIG. 17 may be connected to one another through communication lines and may cooperate with one another. In particular, the hardware configuration may be installed in portable information communication equipment (including a portable phone, a smartphone, a mobile device, and a wearable computer), home information equipment, a robot, a copier, a fax, a scanner, a printer, a multi-function device (an image processing device having at least two of the functions of scanning, printing, copying, faxing, and the like), or the like as well as a personal computer.

In the above-described exemplary embodiments, the example in which the registration date is used is described. However, the medical consultation date may be used instead of the registration date. In the above-described exemplary embodiments, the types of documents handled in various institutions are not always standardized. Therefore, the registration date of a document is used to determine whether or not the document is to be published. If it is possible to extract the medical consultation date from each document, the medical consultation date may be used instead of the registration date. For example, if each document has an attribute of the medical consultation date or describes the medical consultation date, the medical consultation date may be extracted from the document.

In the above-described exemplary embodiments, the example in which medical documents are used as target documents is described, but documents having another type may be used. For example, documents about learning (such as a report card and a report about student's desire) may be used. The exemplary embodiments may be applied to cooperation for college entrance examination in which institutions, such as a high school (corresponding to the above-described core hospital) and a cramming school, participate. The exemplary embodiments may be applied to cooperation for lifelong learning in which institutions, such as a university (corresponding to the above-described core hospital), a museum, a library, and a culture center, participate.

In the description for the above-described exemplary embodiments, the terms “equal to or more than”, “equal to or less than”, “more than”, and “less than” which are used when comparison is made with a predetermined value may be used as “more than”, “less than”, “equal to or more than”, and “equal to or less than”, respectively, as long as no contradictions occur in the combinations.

The programs described above may be provided through a recording medium which stores the programs, or may be provided through a communication unit. In these cases, for example, the programs described above may be interpreted as an invention of “a computer-readable recording medium that stores a program”.

The term “a computer-readable recording medium that stores a program” refers to a computer-readable recording medium that stores programs and that is used for, for example, installation and execution of the programs and distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray® Disk, a magneto-optical disk (MO), a flexible disk (FD), a magnetic tape, a hard disk, a ROM, an electrically erasable programmable ROM (EEPROM®), a flash memory, a RAM, and a secure digital (SD) memory card.

The above-described programs or some of them may be stored and distributed by recording them on the recording medium. In addition, the programs may be transmitted through communication, for example, by using a transmission medium of, for example, a wired network or a wireless communication network which is used for a local area network (LAN), a metropolitan area network (MAN), a wide area network (WAN), the Internet, an intranet, an extranet, and the like, or a combination of these. Instead, the programs may be carried on carrier waves.

The above-described programs may be included in other programs, or may be recorded on a recording medium along with other programs. Instead, the programs may be recorded on multiple recording media by dividing the programs. The programs may be recorded in any format, such as compression or encryption, as long as it is possible to restore the programs.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores a plurality of documents having a predetermined relationship, each of the plurality of documents being stored in association with a registration date;
a registration-interval extracting unit that extracts an interval between the registration dates of the plurality of documents; and
a determining unit that determines that the plurality of documents are to be published if a predetermined day count and the interval between the registration dates of the plurality of documents satisfy a predetermined condition.

2. The information processing apparatus according to claim 1,
wherein the determining unit determines that the plurality of documents are not to be published if the predetermined day count and the interval between the registration dates of the plurality of documents do not satisfy the predetermined condition.

3. The information processing apparatus according to claim 1,
wherein the predetermined relationship is such that the documents describe a plurality of medical records for an identical patient.

4. The information processing apparatus according to claim 2,
wherein the predetermined relationship is such that the documents describe a plurality of medical records for an identical patient.

5. The information processing apparatus according to claim 1,
wherein the predetermined condition is that the interval between the registration dates of the plurality of documents falls within a predetermined range or is equal to or less than one day, the predetermined range being determined with respect to a statistical value of past registration intervals.

6. The information processing apparatus according to claim 2,
wherein the predetermined condition is that the interval between the registration dates of the plurality of documents falls within a predetermined range or is equal to or less than one day, the predetermined range being determined with respect to a statistical value of past registration intervals.

7. The information processing apparatus according to claim 3,
wherein the predetermined condition is that the interval between the registration dates of the plurality of documents falls within a predetermined range or is equal to or less than one day, the predetermined range being determined with respect to a statistical value of past registration intervals.

8. The information processing apparatus according to claim 4,
wherein the predetermined condition is that the interval between the registration dates of the plurality of documents falls within a predetermined range or is equal to or less than one day, the predetermined range being determined with respect to a statistical value of past registration intervals.

9. The information processing apparatus according to claim 1,
wherein the determining unit determines that a document is to be published, the document being a document registered first as having a document type of the plurality of documents having the predetermined relationship, or being a document registered in a predetermined institution.

10. The information processing apparatus according to claim 2,
wherein the determining unit determines that a document is to be published, the document being a document registered first as having a document type of the plurality of documents having the predetermined relationship, or being a document registered in a predetermined institution.

11. The information processing apparatus according to claim 3,
wherein the determining unit determines that a document is to be published, the document being a document registered first as having a document type of the plurality of documents having the predetermined relationship, or being a document registered in a predetermined institution.

12. The information processing apparatus according to claim 4,
wherein the determining unit determines that a document is to be published, the document being a document registered first as having a document type of the plurality of documents having the predetermined relationship, or being a document registered in a predetermined institution.

13. The information processing apparatus according to claim 5,
wherein the determining unit determines that a document is to be published, the document being a document registered first as having a document type of the plurality of documents having the predetermined relationship, or being a document registered in a predetermined institution.

14. The information processing apparatus according to claim 6,
wherein the determining unit determines that a document is to be published, the document being a document registered first as having a document type of the plurality of documents having the predetermined relationship, or being a document registered in a predetermined institution.

15. The information processing apparatus according to claim 7,
wherein the determining unit determines that a document is to be published, the document being a document registered first as having a document type of the plurality of documents having the predetermined relationship, or being a document registered in a predetermined institution.

16. The information processing apparatus according to claim 8,
wherein the determining unit determines that a document is to be published, the document being a document registered first as having a document type of the plurality of documents having the predetermined relationship, or being a document registered in a predetermined institution.

17. The information processing apparatus according to claim 1,
wherein a medical consultation date is used as the registration date.

18. A non-transitory computer readable medium storing a program causing a computer to execute a process for information processing, the process comprising:
storing a plurality of documents having a predetermined relationship, each of the plurality of documents being stored in association with a registration date;
extracting an interval between the registration dates of the plurality of documents; and
determining that the plurality of documents are to be published if a predetermined day count and the interval between the registration dates of the plurality of documents satisfy a predetermined condition.

19. An information processing method comprising:
storing a plurality of documents having a predetermined relationship, each of the plurality of documents being stored in association with a registration date;
extracting an interval between the registration dates of the plurality of documents; and
determining that the plurality of documents are to be published if a predetermined day count and the interval between the registration dates of the plurality of documents satisfy a predetermined condition.
